(19) United States
(12) Patent Application Publication
(10) Pub. No.: US 2006/0188025 A1
(43) Pub. Date: Aug. 24, 2006

(54) Error concealment

(75) Inventor: Miska Hannuksela, Ruutana (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/062,114

(22) Filed: Feb. 18, 2005

(51) Int. Cl. H04B 1/66; H04N 11/04; H04N 7/12; H04N 11/02

(52) U.S. Cl. 375/240.27; 375/240.24

(57) ABSTRACT

An error concealment in decoding of inter-coded information, comprising normative error concealment within a decoding loop and proprietary error concealment outside the decoding loop. The normative error concealment provides meta-data and a reconstructed frame for the proprietary error concealment. Using these, the proprietary error concealment further enhances the reconstructed frame without effecting on the decoding of the inter-coded data. A mobile station, network element and a computer program product using the method have further been described.

### FIELD OF THE INVENTION

This invention relates to error concealment. It relates particularly, but not exclusively, to error concealment of inter-coded data such as motion video.

### BACKGROUND OF THE INVENTION

There are presently various video communication systems, which are prone for corruption of a video bit-stream in a transmission channel. For example, many video applications use an unreliable UDP transport protocol in IP networks, where network elements may discard parts of video bit-streams. This may not present any problem if the transmission channel is fast enough to allow retransmissions without causing an interruption in playing back the video bit-stream, but quite often this is not the case. In many systems, particularly in mobile communication systems, the data communication channel has such a low data bandwidth and such a high cycle time, that retransmissions are out of question and the video streams must be heavily encoded to fit in a limited bandwidth. Typically video encoding is based on so-called inter-coding.

There are two common basic representation formats for uncompressed digital video: interlaced and progressive. In the interlaced format, the array of pixels (or samples) in a capturing and rendering device of the digital video system is divided into two sets: the first set comprising the even-numbered pixel rows and the second set comprising the odd-numbered pixel rows. These sets are commonly referred to as the top field and the bottom field. Capturing (or rendering) of the top field is done at a separate time instant compared to capturing (or rendering, respectively) of the corresponding bottom field. In the progressive format, the array of pixels in a capturing or rendering device is captured or rendered, respectively, at one time instant and is referred to as frame.

Due to the possibility of having either interlaced or progressive uncompressed digital video signal, many video compression systems also include similar coding structures. A coded field is a coded representation of an uncompressed bottom or top field. A coded frame is a coded representation of an uncompressed frame when progressive digital video is in use. A coded picture is a collective term representing both a coded field and a coded frame. The invention is presented in the context of progressive digital video, and therefore only coded frames are considered and terms frame, picture, and image are synonyms in this description.

Video play back is based on displaying a video stream of consecutive video frames. An inter-coding video encoder predicts a new video frame from a frame received earlier (that is from a reference frame). Many coding schemes allow generation of non-reference frames, which are coded and decoded similarly to reference frames but are not allowed to be used as reference for motion compensation for any subsequent frame. The encoder forms a prediction frame based on motion compensated reference, typically resulting into motion vectors specifying the reconstruction of the prediction frame, and then compares the new video frame and the prediction frame, resulting in residual information equal to the difference between these frames. The residual information is typically coded in a lossy manner by transforming the sample values to another domain (for example to Discrete Cosine Transform coefficients), quantizing the resulting transform coefficients, and coding the quantized coefficients with an entropy coder. The coded residual information and motion vectors are provided to the decoder, which reconstructs the video frame by predicting the frame using the motion vectors and enhances the result with the coded residual information.

If even a single decoded video frame has errors (due to communications errors in the motion vectors and/or in the coded residual information), the reference frame becomes erroneous for the next frame resulting in accumulation of errors to all following video frames. Numerous ways have been devised to prepare the video transmission against corruption in the transmission channel. In general, any introduced transmission errors should be first detected and then corrected or concealed by the decoder. Error correction refers to a capability to perfectly correct erroneous data removing all errors from it. Error concealment refers to the capability to conceal the effects of transmission errors so that preferably the errors cause hardly visible deterioration in the reconstructed video. Typically some amount of redundancy is added to on encoding data in order to help error detection, correction and concealment on decoding the data.

Error correction and concealment techniques can be roughly classified into three categories: forward error concealment, receiver-oriented error concealment, and interactive error concealment. Forward error concealment refers to those techniques in which the encoder adds such redundancy that the decoder can recover the data received even if it has got errors during the transmission. In receiver-oriented error concealment methods the decoder attempts to estimate the correct representation of erroneous data. In interactive error concealment, the encoder and decoder co-operate in order to minimise the effect of transmission errors, by heavily using information that the decoder feeds back to the encoder. Receiver-oriented error concealment can also be classified as passive error concealment whereas forward concealment and interactive error concealment can be classified as active error concealment.

A technique known as error tracking or encoder-side error tracking utilizes signalling called videoNotDecodedMBs (specified in ITU-T Recommendation H.245 “Control protocol for multimedia communication,” 7/2001 from a decoder to the far-end encoder. VideoNotDecodedMBs indicates to the far-end video encoder that a set of MacroBlocks (MB) has been received erroneously and that any MB in the specified set has been treated as not coded. The encoder may use this information to compensate transmission errors, as illustrated in Appendix I of ITU-T Recommendation H.263, “Video coding for low bit rate communication”, 2/1998.

A technique known as NEWPRED is presented in this paragraph. NEWPRED is based on the fact that modern video coding methods can make us of several reference pictures for motion compensation and enable selection of reference pictures on sub-picture basis, e.g. per each slice in Annex N of the ITU-T Recommendation H.263 and per each coding block in ITU-T Recommendation H.264, “Advanced video coding for generic audiovisual services,” 5/2003. In the NEWPRED technique a (near-end) decoder transmits indications on losses or erroneous decoding (negative acknowledgment, NACK) and/or correct decoding (positive acknowledgement, ACK) associated with the indication in which picture and which spatial area the loss, erroneous decoding, or correct decoding occurred. The indications can be transmitted “in-band” (videomux mode) included in the video bitstream from the near-end encoder to the far-end decoder. Alternatively, the indications can be transmitted in a separate stream e.g. as described in the RTP/AVPF profile described in J. Ott, S. Wenger, N. Sato, C. Burmeister, J. Rey, “Extended RTP Profile for RTCP-based Feedback (RTP/AVPF),” 10 Aug. 2004, IETF Internet Draft draft-ieff-avt-rtcp-feedback-11.txt. The operation of the far-end encoder depends on whether only ACK messages, only NACK messages, or both messages are transmitted. Here we describe only the NACK-only case without loss of generality. When it is known that only NACK indications are sent, the far-end encoder should respond to a NACK indication such that it does not use the indicated picture area as a prediction reference for motion compensation in any picture at and after the indication is received.

A similar technique compared to NEWPRED, known as videoBadMBs, is specified in the ITU-T Recommendation H.245. VideoBadMBs commands the far-end video encoder to take corrective action when a set of MBs has not been properly received. Unlike videoNotDecodedMBs, the videoBadMBs command lacks any specific definition of how the decoder has treated the specified set of MBs. The encoder shall use this information to take action toward recovery of video quality. The encoder should respond to this command by ensuring that the specified set of macroblocks is not used for the prediction of video pictures subsequent to the encoder's receipt of the command. The specific action to be taken by the encoder is not defined, but may include any appropriate remedial action, such as sending an INTRA frame.

It is essential to standardise non-proprietary communication systems in order to ensure interoperability of communication system elements provided by different manufacturers. In data communication staridards, error concealment can be specified as a normative or non-normative feature of the system. Normative error concealment provides the advantage that the encoder knows exactly how the decoder will handle transmission errors in video signal. Non-normative error concealment allows the decoder to freely apply any error concealment method without restricting technical advance. The operation of a video encoder can, however, be optimised if it knows how a far-end decoder conceals errors. A non-standard (proprietary) error concealment method should not be used in a system where error concealment is a normative feature. The encoder may otherwise assume wrongly how the receiver handles transmission errors, which may easily result in a poor image quality.

Both in normative and non-normative error concealment, the concealed images are typically used as reference images (frames) for decoding subsequent coded images. In other words, error concealment is typically an operation that happens within the decoding algorithm of a picture. The use of the error concealed frame as a reference frame rather typically results in less severe error accumulation to following frames than the use of a frame having errors without the error concealment. The use of an error-concealed frame as a reference frame will hereinafter be referred to as in-loop error concealment.

Present video coding standards typically specify how an error-free bit-stream must be decoded. They do not typically specify how missing or corrupted data must be handled, but rather concealment of transmission errors has been left as an implementation-specific issue.

FIG. 1 presents a simplified block diagram of a conventional motion-compensation-based video decoder 10 that is capable of concealing transmission errors in coded video signal 12. The decoder 10 is assumed to conform to a video decoding standard. A variable length decoding (VLD) block 11 parses coding parameters 13 from an incoming video bit-stream 12. The coding parameters 13 are fed in two parallel blocks, texture decoding block 14 and motion compensation block 15. The texture decoding block 14 decodes textures for the image and the motion compensation block 15 computes new placements for various image segments as is know from the art of motion compensated video decoding. The decoded textures are provided to a summing switch 16, that has inputs for two other signals, one for an output of the motion compensation block 15 and another for an intra-coded signal. The summing switch 16 provides an output to a error concealment block 17, which performs error concealment, if necessary. The video frame after the error concealment block 17 (either error concealed or not) is given as an output both to an output device or process (for example, a display) generally referred to as a sink, and to a reference buffer 18. The reference buffer 18 buffers earlier frames and provides them to the motion compensation block 15 for its use. The coding parameters 13 may also control the operation of the summing switch 16 and the error concealment block 17, even though that is not drawn in the FIG. 1 in sake of simplicity. Blocks 11, 14, 15, 16, 17, and 19 represent the elements of a decoding loop in the presented motion-compensated-based video decoder. Phrase “decoding loop” arises from the fact that a picture may be used as input (that is prediction reference for motion compensation) for decoding a subsequent picture. When an operation or block affects the decoded picture stored in the reference image buffer, it is referred to as an in-loop operation or block.

The operation of the decoder 10 is next further described. The texture decoding block 14 reconstructs INTRA images (images based on information content corresponding to other parts of the same frame) and areas as well as the difference between motion-compensated prediction image or area and the image or area to reconstruct. The motion compensation block 15 generates the prediction image or area that resembles the image to reconstruct as much as possible. The motion compensation block 15 uses previously reconstructed images from the reference image buffer 19 as one input and the coding parameters 13 as another input. In case of INTER image or area decoding (decoding based on another frame), the prediction image or area is summed up with the result of the texture decoding block 14, and the end-result is passed to the error concealment block (17). In case of INTRA image or area decoding, the result of texture decoding is directly passed to the error concealment block 17. Notice that the error concealment block 17 can either perform normative or non-normative error concealment. The error concealment block 17 may apply motion-compensated error concealment and use previous reconstructed images stored in the reference image buffer 19. If there are no transmission errors in the image, the error concealment block passes information without processing it. Finally, the concealed (or decoded image without concealing, if no concealing is required) image is stored to the reference image buffer 19 and provided to the sink 18.

Supposing that the decoder 10 exemplified a decoder according to a standard where normative error concealment has been specified. In this case, all video decoders conforming to this standard will be restricted to a pre-defined set (one or more) of error concealment algorithms. This set of algorithms may not be the best one for all applications, video sequences or transmission error patterns.

### SUMMARY OF THE INVENTION

It is an objective of the invention to avoid or at least mitigate the present problems in concealment of transmission errors.

According to a first aspect of the invention there is provided an apparatus, comprising:

a decoder for decoding information;

a first error concealment block for applying a first concealment of errors in the decoded information; and

a second error concealment block for applying a second concealment of errors in the decoded information, wherein the decoder is configured to at least occasionally decode the information based on previously decoded information using the first but not the second concealment of errors.

The apparatus may be used to provide a first error concealment within decoding loop and a second error concealment outside the decoding loop.

The errors concealed may be transmission based or they may have occurred on recovering the information from storage, for example magnetic medium such as magnetic tape, disc, stripe or optical medium such as a CD or DVD disc.

The invented apparatus may conceal unexpected or unintentional errors not due to inaccuracy in encoding but generally errors induced in the process of obtaining the information.

Advantageously, proprietary error concealment methods may be used in communication systems that employ normative error concealment even if data transmitted is inter-coded. Further, it is possible to apply consecutive error concealment processes, where one of the processes affects on further decoding through changes in reference frames, whereas another error concealment process does not affect on further decoding, as residing outside the decoding loop.

Even further, the invented apparatus allows unlimited number of different error concealment methods being used in the second error concealment procedure without imposing need for the encoders to be aware of methods used in the second concealment procedure, as reference frames are not affected by the second procedure.

According to a second aspect of the invention there is provided a method for error concealment comprising:

decoding information;

applying a first concealment of errors in the decoded information; and

applying a second concealment of errors in the decoded information, wherein the step of decoding at least occasionally decodes the information based on previously decoded information using the first but not the second concealment of errors.

The information may be video information and/or audio information. The information may be inter-coded or intra-coded. The information may be processed in information frames so that the information is received on a frame-by-frame basis and the decoding of one frame is based on an earlier decoded frame, so-called reference frame. A segment or sub-frame of a frame may be decoded based on another segment or sub-frame of the same or another frame.

Preferably, the method further comprises the step of video encoding a series of video frames comprising the first and the subsequent video frame before their decoding, characterised in that the first error concealment procedure has been optimised for the video encoding.

Preferably, the first error concealment maybe applied by a procedure comprising at least one particular predetermined error concealment method.

Preferably, the second error concealment maybe applied by a procedure comprising at least one particular error concealment method.

Error concealing information may be provided from the first error concealment to the second error concealment. This may provide details that allow efficient proprietary refinement of once error concealed information frames. Alternatively, the second error concealment may partially or entirely neglect the first error concealment.

The error concealing information may comprise information relating to an error occurring in a decoded frame. Such information helps the second error concealment procedure to error conceal the information.

The error concealing information may comprise at least one of the following: the location of an error region comprising an error or errors, the shape of the error region, and the size of the error region. The error concealing information may further comprise information for identifying error concealment method or methods used in applying the first error concealment. The error concealing information may further comprise information included or derived from the current coded frame or the previous coded frames, such as the correctly decoded motion vectors and coding types. The coding type may indicate the use of intra-coding and/or inter-coding.

The applying the first error concealment may be a normative procedure defined in a standard defining the decoding of the information. The method of the third aspect removes the need to standardise all different error concealment methods allowing nevertheless them being used without surprising effects caused through error accumulation (because of the inter-decoding effects caused by erroneous reference frames).

The applying of the first error concealment may comprise a first set of error concealment methods in order to guarantee a consistent minimum reconstructed image quality.

The applying of the first error concealment may comprise a non-normative procedure that has not been defined in an information decoding standard according to which the decoding is performed.

The second error concealing procedure may be dynamically adapted to scale the computation and/or power consumption demand of the decoder to a desired level. As a result, a complex error concealment method (algorithm) can be used if there is a lot of available computing power, whereas the block can be partially or completely passed by if little or no spare processing power is available.

A reverse link may be provided for communications from a decoder to the originator of the information that is being decoded. The decoder may send to the originating encoder an indication of a detected defective decoding (due to loss, corruption or erroneous received information.

There may be a set of error concealment algorithms from which the decoder can select a suitable one dynamically. The selection may be done for example based on decoder's evaluation of the resulting picture quality or the available computational resources in the decoder. The indication of defective decoding may include identification of an algorithm from the set of error concealment algorithms used in the decoder.

The encoder may use indicated normative error concealment to form a decoded picture identically to the picture for the reference image buffer in the decoder. Conversely, the encoder may use any pictures and areas as prediction reference for motion compensation regardless whether there were correctly decoded, were error-concealed, or one of their prediction references was incorrectly decoded.

Alternatively, the encoder may use a picture as prediction reference before either ACK or NACK feedback regarding the picture has been received so that if a NACK message regarding the picture is later received, then the encoder regenerates the decoded pictures that are affected by the loss using the indicated error concealment algorithm. Advantageously, such regeneration of a reference picture may drastically enhance the subjective quality of video transfer.

The recipient of feedback information described in the previous paragraph may be a device transmitting pre-encoded content, in which case the pre-encoded content contains different versions, each suitable for a particular feedback reporting, and the transmitting device selects the version to the transmit according to the feedback reporting.

According to a third aspect of the invention there is provided a computer program stored on a memory media which when executed by an apparatus causes the apparatus to conceal errors, comprising:

computer executable program means to enable the apparatus decoding information;

computer executable program means to enable the apparatus applying a first concealment of errors in the decoded information; and

computer executable program means to enable the apparatus applying a second concealment of errors in the decoded information, wherein the decoding at least occasionally decodes the information based on previously decoded information using the first but not the second concealment of errors.

According to a fourth aspect of the invention there is provided an apparatus for serving an information decoding and error concealing client apparatus; comprising:

a buffer for storing a reference frame and further information;

an encoder capable of encoding a present information frame based the reference frame;

an input for receiving feedback information from the client apparatus;

an error tracking unit capable of reconstructing an information frame corresponding to the client apparatus based on the feedback information if the feedback information indicates that the client device has performed error concealment, adapted to store a corresponding reference frame in the buffer so that the encoder subsequently encodes information based on a common reference frame with the decoder; wherein the feedback information consists of one of the following:

negative acknowledgement (NACK) message for a first corrupted information frame for any series of information frames affected by a given transmission error; and

acknowledgements for successfully decoded information frames and a negative acknowledgment (NACK) message for a first corrupted information frame for any series of information frames affected by a given transmission error.

Various embodiments of the present invention have been illustrated only with reference to the one aspect of the invention for sake of briefness, but it should be appreciated that corresponding embodiments may apply to other aspects as well.

### BRIEF DESCRIPTION OF THE DRAWINGS

The invention will now be described, by way of example only, with reference to the accompanying drawings, in which:

FIG. 1 presents a simplified block diagram of a conventional motion-compensation-based video decoder;

FIG. 2 presents a simplified block diagram of a motion-compensation-based video decoder according to a preferred embodiment of the invention;

FIG. 3 presents a wireless communication system comprising the decoder of FIG. 2; and

FIG. 4 presents an exemplary block diagram of an encoder according to an embodiment of the invention.

### DETAILED DESCRIPTION

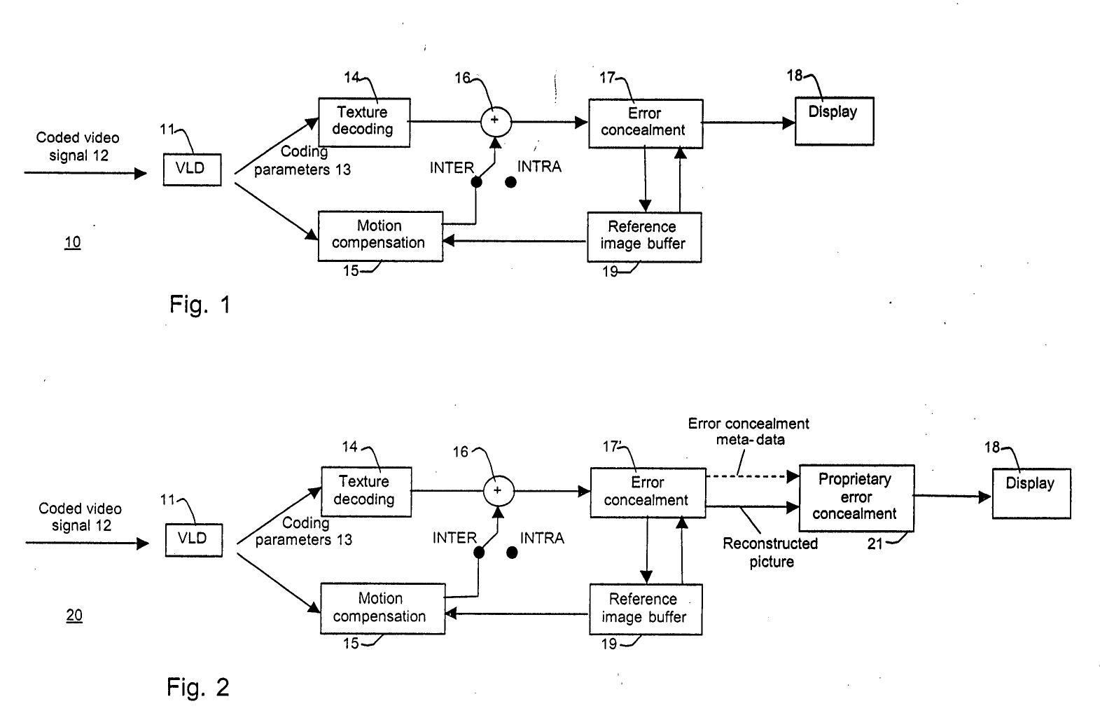

FIG. 1 has been described in the foregoing. In the following, corresponding reference signs have been applied to corresponding parts.

FIG. 2 presents a simplified block diagram of a motion compensation based video decoder 20 according to a preferred embodiment of the invention. The decoder comprises a decoding loop similar to that in FIG. 1 and outside the decoding loop a proprietary error concealment block 21. The error concealment block within the decoding loop is a normative error concealment block 17′ differing over a prior art error concealment block in that it is preferably capable of outputting error concealing information or error concealment meta-data for use in subsequent error concealment in the proprietary error concealment block 21. The proprietary error concealment block 21 enhances the concealed areas after the normative error concealment block 17′. This enhancement is generally performed by supplementary error concealment, that is, by applying a second error concealment operation to an already error concealed an image or part of an image. Alternatively, the normative error concealment is replaced by applying a more effective error concealment algorithm to the non-concealed image data, coded data. The normative and the proprietary error concealment blocks (17′, 21) are capable of performing a first and a second error concealment procedure, respectively. The normative error concealment block 17′ inside the decoding loop is configured to provide the proprietary error concealment block 21 with the reconstructed picture and with error concealment meta-data 22 related to areas that have been concealed in the normative error concealment block 17′. Alternative to providing the meta-data 22, the proprietary error concealment block operates on the decoded information without error concealment produced by the normative error concealment block 17′.

The meta-data includes one or, more of the following:
Location, shape, and/or size of concealed areas within the frame.
The identification of a particular error concealment method (for instance, an algorithm) used for a specific area.
Correctly or erroneously received coding parameters related to a specific concealed area.
Coded bit-stream related to a specific concealed area.
Indication of which parameters or which parts of the bit-stream where received correctly, contain bit-errors, or are lost.
Further information concerning bit-error characteristics of a corrupted bit-stream possibly including an indication of corrupted or correctly received segments of the bit-stream.
Coding parameters such motion vectors and coding types (e.g. intra and inter), related to correctly decoded areas in the current and previous frames.

An example of utilisation of the meta-data 22 follows. If the proprietary error concealment block 21 receives information that motion vectors and residual information of an indicated area have been received correctly, it does not attempt to conceal errors. However, if motion vectors and/or the residual information were not correctly received, the proprietary error concealment block 21 typically attempts concealment based on motion in neighbouring correctly received areas. The proprietary error concealment is performed as a post-processing operation, and therefore the enhanced images are not stored in the reference image buffer. Thus, this process complies with a typical video coding standards which do not normatively define any post-processing operations.

In an embodiment of the invention, it depends on available computation power and resources whether the proprietary error concealment block 21 performs error concealment or not in case of an erroneous motion vectors. For example, in a battery operated mobile device comprising the decoder 20, the proprietary error concealment block 21 may be used only when the motion vectors are erroneous above a set threshold level. On the other hand, the decoder can be configured to choose and apply an error concealment algorithm from a set of algorithms so that the complexity and effectiveness of the algorithm depends on some criterion or criteria. Such criteria may include the severity of the errors, the energy available to the decoder to operate, and/or a selection made by the user (low-power profile or high quality decoding).

In a further embodiment of the invention, the proprietary error concealment block 21 conceals errors by estimating erroneous motion vectors based on other motion vectors of the same frame. In this embodiment, the proprietary error concealment procedure comprises an intra-frame method for concealing errors. For example, let us assume that the only normative error concealment algorithm that is used for INTER-coded areas is copying the spatially corresponding area from the previous reconstructed picture. For areas having little or no motion this algorithm works well. However, for areas having a considerable amount of motion, the algorithm typically fails. Thus, the proprietary concealment block 21 may use the following algorithm to replace the normatively concealed area:
Collect the correctly received motion vectors of the adjacent areas (assuming that the coding scheme uses translational motion-vector based motion compensation).
Select the median of the collected motion vectors.
Use the median vector to compensate motion for the area to be concealed.

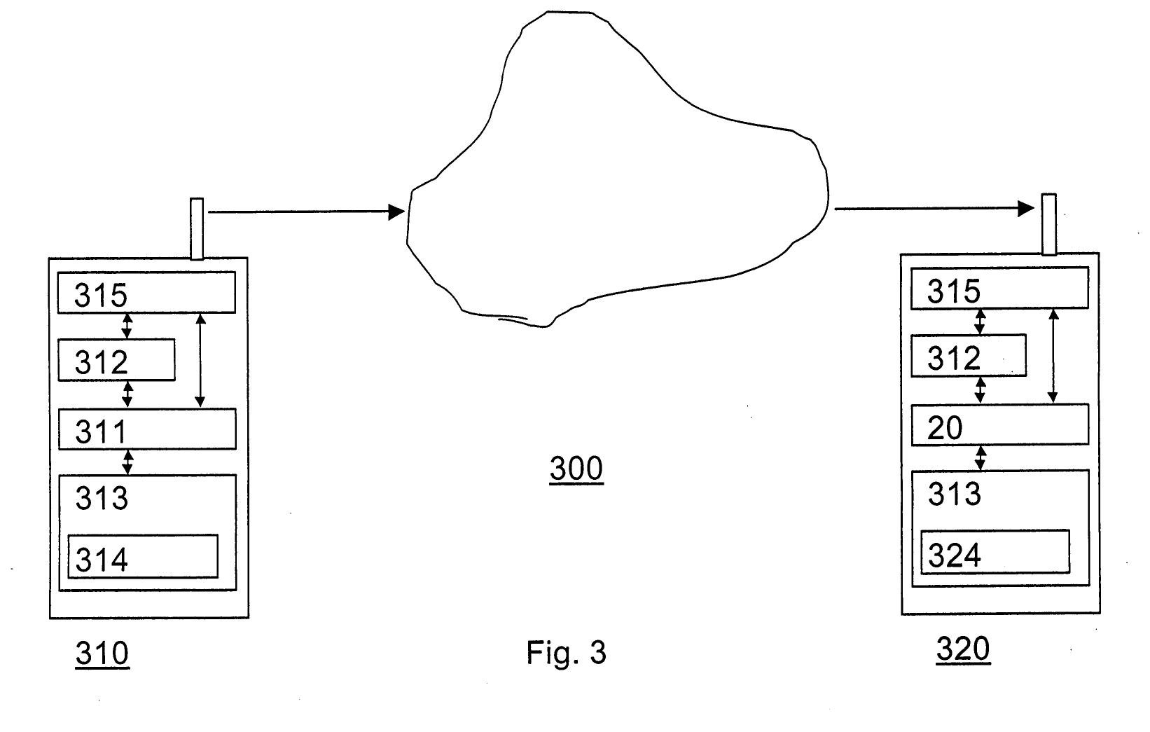

FIG. 3 presents a mobile telecommunications network 300 that comprises a first and a second battery operated mobile station 310 and 320. The first and second battery operated mobile stations 310 and 320 comprise a video encoder 311 and a video decoder 20, respectively. The first and second battery operated mobile stations 310 and 320 further comprise a battery 312 as an energy source and a memory 313 for storing information. The memory 313 of the first battery operated mobile station 310 comprises computer program code 314 for controlling the encoder 311. The memory 313 of the second battery operated mobile station 320 comprises computer program code 324 for controlling the decoder 20. Both the first and second battery operated mobile station 310, 320 comprise a radio transceiver 315 for communication with the telecommunication network 300.

The video encoder 311 is a conventional video encoder that advantageously (though not necessarily) knows the normative error concealment procedure 17 (shown in FIG. 2) of the video decoder 20. Typically, the computer program code 314 is compatible with the normative error concealment process and thus runs a first video encoding procedure with which the normative error concealment procedure 17 works well. Alternatively, the decoder may signal its state over a reverse link to the encoder.

The operation of the video decoder 20 has been basically described with reference to FIG. 2. In addition, it is configured capable of receiving operating instructions defining the proprietary video concealment procedure 21 via the radio transceiver 315 and to store the instructions in the memory 313. This capability allows flexible and cost efficient configuration and reconfiguration of mobile stations by which their video decoding capability can be improved over the air.

In FIG. 3, the mobile stations are shown with only an encoder 311 or a decoder 20. Whilst this can sometimes be the case, in the preferred embodiment the mobile stations comprise both video encoders and decoders for bi-directional video communication.

A reverse link is typically provided so that the originator, for example a transmitting mobile station, can receive decoding related information from a decoder. The decoding related information preferably contains an indication of errors encountered during decoding (for instance, due to loss, corruption or erroneously received information). The decoding related information may also contain at least one of the following: an indication whether a reported defective decoding is due to a transmission loss or corruption in the indicated picture or due to a propagation of corruption from any of the prediction sources, an indication of the error concealment algorithm used to conceal loss or corruption of information received, and an indication of the error tracking algorithm the decoder uses for tracking propagation of loss and corruption. The indication of a detected loss or corruption or erroneous decoding preferably corresponds to one of the following: NEWPRED, videoBadMBs, and videoNotDecodedMBs. Any of the aforementioned indications can also contain additional information. Alternatively, some additional information may be transmitted in a separate message. Some information, such as the indication of the concealment algorithm used and/or an identification of the error tracking algorithm used can be transmitted during session setup.

The recipient of feedback information, for example transmitting mobile station, described in the foregoing is typically an encoder performing real-time encoding, possibly for live content. When such an encoder providing real-time content receives a negative acknowledgement indicating a loss or corruption of data, according to the invention it reconstructs the corresponding decoded picture as if it were the decoder. In other words, the encoder can use the indicated normative error concealment to form a decoded picture identically to the picture for the reference image buffer in the decoder. The indication allows the encoder to use different pictures and areas as prediction reference for motion compensation typically regardless whether these were correctly decoded, were error-concealed, or one of their prediction references was incorrectly decoded.

Due to transmission round-trip delays and processing delays, the encoder typically codes and transmits pictures before a presently encoded picture is completely decoded in the far-end decoder and, in case of transmission errors, the feedback messages related to the presently encoded picture are received from the far-end decoder through the reverse link. Accordingly, the encoder should not use a picture as prediction reference before delivery status (either ACK or NACK) feedback regarding the picture is received in order to avoid an extended severe distortion in inter-coded data. Alternatively, the encoder may use a picture as prediction reference before the delivery status feedback regarding the picture has been received. If the delivery status feedback regarding the picture later indicates that an error has occurred, then the encoder regenerates the decoded pictures that are affected by the error using the indicated error concealment algorithm. That is, the encoder regenerates the reference frame used by the decoder and adapts its own operation such that both the encoder and decoder will subsequently use again the same error concealed reference in inter-coding.

For the pictures subsequent to the indicated picture containing a loss or corruption, the encoder may track the propagation of the loss or corruption with the indicated error-tracking algorithm. The decoder may also send indications about incorrect decoding due to incorrectly decoded prediction references for motion compensation. In other words, when a motion vector in a picture currently being decoded refers to a block in a previously decoded picture which is incorrectly decoded, the decoder may send an indication about incorrect decoding of the currently decoded block. When the encoder receives a negative acknowledgement about an incorrectly decoded area due to incorrectly decoded prediction references and the location, shape, and size of the area is not identical to the location, shape, and size (respectively) of the area the encoder has concluded based on the initial loss/corruption indication and error tracking, then at least one of the indications have been lost and the encoder should no longer use this area (reported within the latest negative acknowledgement) as prediction reference for succeeding pictures.

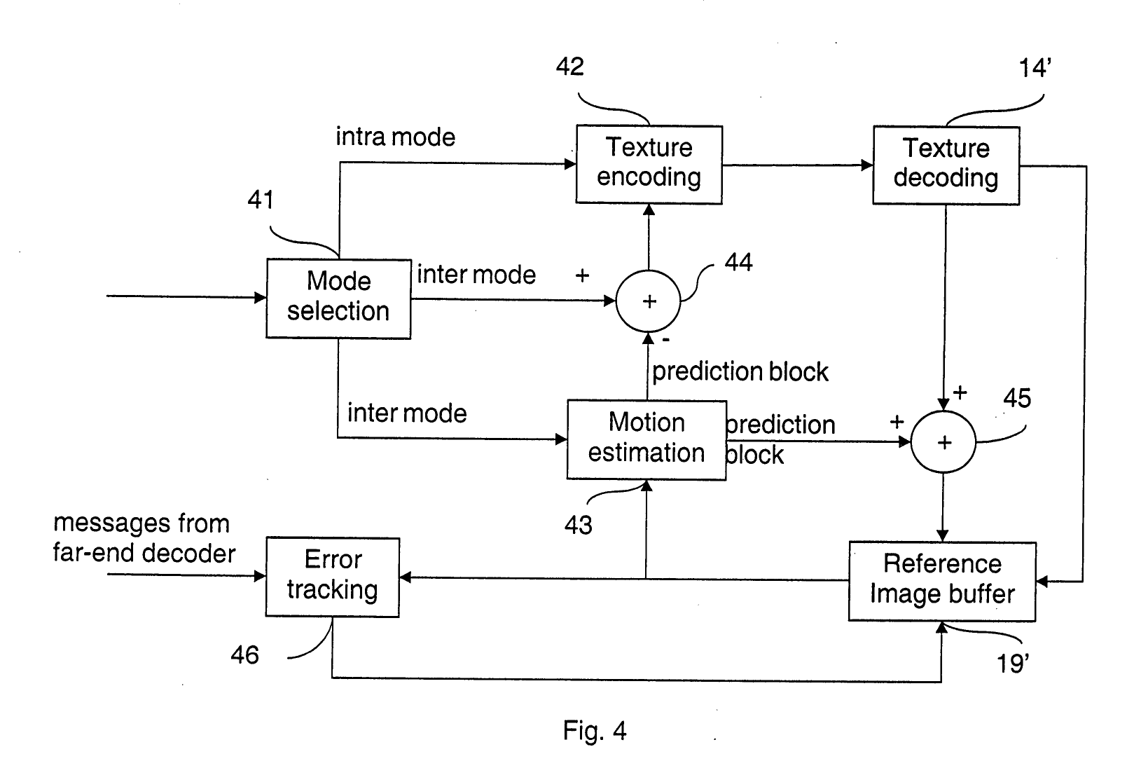

The preferred encoder operation according to the invention is described next with reference to FIG. 4 showing an exemplary block diagram of the encoder 311. The encoder 311 comprises, a coding mode selection block 41, a texture encoding block 42 controlled by the mode selection block 41, a motion estimation block 43 also controlled by the mode selection block 41, a first summing unit 44 connected to the model selection block 41, texture encoding block 42 and the motion estimation block 43. The encoder 311 further comprises a texture decoding block 14′ downstream from the texture encoding block 42, reference image buffer 19′ and a second summing unit 45 interposed between the texture decoding block 14′, the motion estimation block 43 and the reference image buffer 19′. Further, the encoder 311 comprises an error tracking block 46 for receiving messages for an far-end decoder and adapting the reference image buffer 19′. The operation of the encoder will be explained with further detail after the description.

The encoder 311 and the far-end decoder 20 negotiate or one of the endpoints chooses one of the following modes of operation for the reverse link:
ACK mode: ACK messages, no NACK messages
Simple NACK mode: No ACK messages, NACK messages for first-time transmission loss only
Error-tracked NACK mode: No ACK messages, NACK messages for all decoding errors
Combined ACK and simple NACK mode: ACK messages, NACK messages for first-time transmission loss only
Combined ACK and error-tracked NACK mode: ACK messages, NACK messages for all decoding errors

Alternatively, any subset including only one of the modes presented above may be available for negotiation or choosing the mode.

In the following, it is assumed that the messages passing over the reverse link are transported using an unreliable transmission protocol. In other words, the messages may be lost. It is assumed that the integrity of the messages is protected e.g. by cyclic redundancy check and therefore no corruption of messages is considered below.

The reference image buffer 19′ contains the decoded pictures that can be used as references in the motion estimation process. In addition to the decoded pictures, it contains information about error concealment that was performed in the far-end decoder. For each decoded picture, an error-track picture is stored. Elementary elements in an error-track picture depend on the error tracking algorithm and may be for example: a sample (i.e. a pixel), a sub-block (e.g. a 4×4 rectangle of pixels), or a block (corresponding to the unit of motion compensation). For each elementary unit in an error-track picture, an error concealment state is stored. Valid states include but are not limited to the following: “correctly decoded”, “unknown” (that is, possibly correctly decoded or error-concealed), “normatively error-concealed”, and “uncontrollably error-concealed”. In addition, other pieces of essential information for error concealment and error tracking, such as motion vectors, reference picture indexes for motion compensation, and coding types are stored.

The error tracking unit 46 operates as follows. When a reference picture is initially stored to the reference image buffer 19′, a state “unknown” is set for all elementary units of the corresponding error-track picture. The encoder operation depends on the operation mode of the reverse link as described below.

In the ACK mode, a state “correctly decoded” is set for those elementary units for which an ACK message is received. At the start of each scene (a shot from one camera), the encoder uses any elementary units from that shot as prediction references for motion estimation. Since the reception of the first ACK message for the scene, the encoder uses only elementary units marked as “correctly decoded” as prediction references for motion estimation.

In the Simple NACK mode, the encoder or originating terminal estimates or gets the information about the round-trip delay from sending a coded picture until the latest possible moment of receiving a NACK message for that picture. The encoder uses only those pictures (after the first picture of the scene) as prediction references for motion estimation of the current picture from which more time than the round-trip time has elapsed. When a NACK message is received, the encoder has three options based on its processing power:
1) An encoder with minimal amount of processing power avoids using any reference pictures between the reference picture corresponding to the NACK, inclusive, and the latest coded reference picture, inclusive, as reference pictures for motion estimation, and therefore all elementary units for these pictures are set to “uncontrollably error-concealed”.
2) An encoder with modest amount of processing power sets a state “normatively error-concealed” for those elementary units for which a NACK message is received and applies the normative error concealment algorithm for the elementary units corresponding to the NACK message. Then, the encoder avoids using any reference pictures between the reference picture corresponding to the NACK, exclusive, and the latest coded reference picture, inclusive, as reference pictures for motion estimation.
3) An encoder with good deal of processing power sets a state “normatively error-concealed” for those elementary units for which a NACK message is received and applies the normative error concealment algorithm for the elementary units corresponding to the NACK message. Then, each time a NACK message is received for a new picture and when there is a reference picture for which the transmission time and the current time is more than the round-trip delay, the encoder decodes the picture again and replaces the corresponding picture in the reference image buffer with the newly decoded picture. Elementary units marked as “normatively error-concealed” as prediction reference are also marked as “normatively error-concealed”. Alternative to the decoding of the encoded images, the encoder may use more buffer memory and store the images without any encoding so as to avoid coding errors from accumulating. Then, the decoding of the picture again is not necessary.

An encoder in the error-tracked NACK mode operates identically to an encoder in the simple NACK mode with the following exception: If the areas indicated in NACK messages indicating incorrect decoding due to incorrect prediction for a particular picture are not the same as the elementary units marked as “normatively error-concealed” at the time the picture is re-decoded, then the encoder concludes that a NACK message has been lost and refreshes the picture in intra mode either gradually over a number of pictures or at once using an intra picture.

An encoder in the combined ACK and simple NACK mode operates identically to an encoder in the error-tracked ACK mode with the following exception: When there are elementary units marked as “correctly decoded” or “normatively error-concealed” available in the same scene, only those elementary units are used as reference.

An encoder in the combined ACK and error-tracked NACK mode operates identically to an encoder in the combined ACK and simple NACK mode with the following exception. If the areas indicated in NACK messages indicating incorrect decoding due to incorrect prediction for a particular picture are not the same as the elementary units marked as “normatively error-concealed” at the time the picture is re-decoded, then the encoder concludes that a NACK message has been lost and marks the corresponding elementary units as “uncontrollably error-concealed” and does not use them as prediction references. Furthermore, if an elementary unit in a later picture uses an elementary unit marked as “uncontrollably error-concealed” as a prediction reference, it is also marked as “uncontrollably error-concealed”.

The encoder processes an input picture block by block. For each block, mode selection 41 is done to select between intra and inter coding. Inputs for mode selection typically include at least some of the following: controls signals from bitrate control algorithm and intra refresh algorithm as well as feedback from texture encoding and motion estimation processes. However, none of the inputs and the related units are shown in the figure to keep it simple. The mode selection process handles the input and may for example include a scene cut detector, and as an outcome it creates an indication whether the block is intra-coded or inter-coded. In order to create the feedback, the texture encoding and motion estimation algorithms may be partially or fully applied. An example of partial motion estimation is to consider the zero motion vector only or the motion vector resulting from the motion vector prediction process specified for decoding. Rate-distortion optimization may be used in the mode selection process.

When the inter coding mode is selected, the motion estimation unit 43 creates motion vectors representing the location of a prediction block and its reference picture. The motion estimation can be done as in typical encoders with multiple reference pictures, taking into account the restrictions created in the error tracking process. The motion estimation unit also outputs the prediction block to a summing unit 44. The summing unit subtracts the prediction block sample-wise from the block to be coded and hands the resulting difference block to the texture encoding unit 42.

When the intra coding mode is selected, the block to be coded is an input to the texture encoding unit 42. The texture encoding unit compresses the input block typically using transform coding, such as Discrete Cosine Transform, and quantization of the resulting transform coefficients. The texture decoding unit 14′ reconstructs sample values from the compressed representation resulting from the texture encoding unit. Typically the texture decoding unit re-scales the quantized transform coefficients back to their original dynamic range and performs an inverse transform. If the block is intra-coded, the result of the texture decoding is stored into the current decoded picture. If the block is inter-coded, a summation unit 45 sums up the prediction block and the result of texture decoding sample-wise and stores the summed block into the current decoded picture. When all blocks of a picture have been coded and the current decoded picture is a reference picture, the current decoded picture is stored in the reference image buffer.

The motion estimation unit and the texture encoding unit also output the variable length encoding unit, which converts the values of the coding parameters, such as transform coefficients and motion vectors, to bits according to the specified syntax for the compression format. For simplicity the variable length encoding unit is not shown in the figure.

The recipient of the feedback information described in the foregoing need not normally encode the content. Instead, the recipient may be a device transmitting pre-encoded content. The pre-encoded content contains different versions, each suitable for a particular feedback reporting, and the transmitting device selects the version to the transmit according the feedback information. A transmitting device using pre-encoded content is preferably capable of encoding the content in case that the error concealment necessitates changing the reference frame.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. A number of features were described as part of examples in the foregoing and wherever technically possible, the features should be regarded as optional and combinable with any different other examples of the description. Hence, the scope of the invention is only restricted by the attached patent claims.

1. An apparatus, comprising:
a decoder for decoding information;
a first error concealment block for applying a first concealment of errors in decoded information; and
a second error concealment block for applying a second concealment of errors in the decoded information, wherein the decoder is configured to at least occasionally decode the information based on previously decoded information using the first but not the second concealment of errors.

2. An apparatus according to claim 1, wherein the information is video information.

3. An apparatus according to claim 1, wherein said second error concealment block is configured to obtain error concealing information regarding the first error concealment, the error concealing information comprising at least one item selected from a group consisting of the following: location of an error region comprising an error or errors, shape of the error region, and the size of the error region.

4. An apparatus according to claim 3, wherein the error concealing information further comprises information for identifying error concealment method or methods having been used in error concealing a subsequent decoded frame.

5. An apparatus according to claim 1, wherein the first error concealment block is configured to apply a normative error concealment specified in an information decoding standard.

6. An apparatus according to claim 2, wherein the first concealment complies with a first set of error concealment methods in order to guarantee a consistent minimum reconstructed image quality.

7. An apparatus according to claim 1, wherein the second error concealment provides non-normative error concealment.

8. An apparatus according to claim 1, wherein the second error concealment block is configured to adapt its operation to scale computation and/or power consumption demand of the apparatus to a desired level.

9. An apparatus according to claim 1, wherein the apparatus is selected from a group consisting of: a video telephone, a mobile video telephone, a network element in a mobile telecommunications network, a media player and a mobile media player.

10. An apparatus according to claim 1, wherein the information comprises a series of information frames and the apparatus comprises a transmitter for sending to an originator of the information being decoded feedback information concerning success of decoding, the feedback information consisting of one of the following:
negative acknowledgement (NACK) message for a first corrupted information frame for any series of information frames affected by a given transmission error; and
acknowledgements for successfully decoded information frames and a negative acknowledgement (NACK) message for a first corrupted information frame for any series of information frames affected by a given transmission error.

11. An apparatus according to claim 1, further comprising an encoder for encoding information in a two-way session, wherein the encoder comprises a transmitter for transmitting encoded information to a recipient and a receiver for receiving feedback information from the recipient and wherein the encoder is configured to adapt its reference frames based on the feedback information.

12. An apparatus according to claim 11, wherein the adaptation of the reference frame is selected from the group consisting of:
receiving a NACK message identifying a given information frame or a particular portion thereof and, in response thereto, applying a pre-determined error concealment algorithm for the frame or portion thereof so that the encoder avoids using any reference frames between a reference frame corresponding to the NACK message, exclusive, and a latest coded reference frame, inclusive, as a reference frame for predictive coding; and
receiving a NACK message for an earlier transmitted information frame and, in response thereto, determining whether a transmission time and a current time is more than a present round-trip delay and if yes, encoding again intervening unsent information frames using a pre-determined error concealment algorithm for those information frames.

13. An error concealment method for error concealment comprising:
decoding information;
applying a first concealment of errors in decoded information; and
applying a second concealment of errors in the decoded information, wherein the step of decoding at least occasionally decodes information based on previously decoded information using the first concealment of errors but not the second concealment of errors.

14. An error concealment method according to claim 13, wherein the first error concealment is applied by a normative procedure comprising at least one particular predetermined error concealment method.

15. An error concealment method according to claim 13, wherein the first error concealment is applied by a proprietary procedure comprising at least one particular predetermined error concealment method.

16. An error concealment method according to claim 13, wherein the decoding further comprises sending to an originator of the information being decoded an indication of a detected defective decoding.

17. An error concealment method according to claim 13, wherein on the first error concealment, error concealing information is produced for the second error concealment, the error concealing information comprising at least one item selected from a group consisting of the following: location of an error region comprising an error or errors, shape of the error region, and size of the error region.

18. An error concealment method according to claim 17, wherein the error concealing information further comprises information for identifying error concealment method or methods having been used in error concealing a subsequent decoded frame.

19. An error concealment method according to claim 13, wherein the information is video information and the first error concealment complies with a first set of error concealment methods in order to guarantee a consistent minimum reconstructed image quality.

20. An error concealment method according to claim 13, wherein the applying of the second concealment of errors is dynamically adapted to scale computation and/or power consumption demand to a desired level.

21. A computer program stored on a memory media which when executed by an apparatus causes the apparatus to conceal errors, comprising:
computer executable program means to enable the apparatus in decoding information;
computer executable program means to enable the apparatus applying a first concealment of errors in decoded information; and
computer executable program means to enable the apparatus applying a second concealment of errors in the decoded information, wherein the decoding at least occasionally decodes the information based on previously decoded information using the first concealment of errors but not the second concealment of errors.
